(19) United States
(12) Patent Application Publication
(10) Pub. No.: US 2023/0101781 A1
(43) Pub. Date: Mar. 30, 2023

(54) PACIFIER WITH CHEEK STABILIZERS

(71) Applicants: Michael Rhodes, Ft. Lauderdale, FL (US); Jackie Rhodes, Ft. Lauderdale, FL (US)

(72) Inventors: Michael Rhodes, Ft. Lauderdale, FL (US); Jackie Rhodes, Ft. Lauderdale, FL (US)

(21) Appl. No.: 17/941,411

(22) Filed: Sep. 9, 2022

Related U.S. Application Data
(60) Provisional application No. 63/242,836, filed on Sep. 10, 2021.

(51) Int. Cl. A61J 17/00

(52) U.S. Cl. CPC A61J 17/001

(57) ABSTRACT

A pacifier includes a shield and a body. The body includes a proximal end portion coupled to the shield, a distal end portion opposite the proximal end and defining a nipple, and one or more stabilizers defined between the proximal end and the distal end. The one or more stabilizers extend outwardly from the body and each define an axis perpendicular to a major longitudinal axis of the body.

### CROSS REFERENCE TO RELATED APPLICATION(S)

This application claims benefit of U.S. Provisional Application No. 63/242,836 filed on Sep. 10, 2021, entitled “Pacifier with Cheek Stabilizers” which is incorporated herein by reference in its entirety.

### FIELD OF THE INVENTION

This invention relates to pacifiers, and more particularly, to pacifiers with cheek stabilizers.

### BACKGROUND

A pacifier, often called a “binky,” is used to calm a baby. The baby will suck on the nipple of the pacifier in between feedings as the nipple of the pacifier is meant to mimic the nipple of the baby's mother. Normally, a pacifier will also include a shield to prevent the baby from choking on the pacifier. However, oftentimes existing pacifiers will not stay in the baby's mouth as there is nothing to prevent the baby from spitting the pacifier out of their mouth.

### SUMMARY

Embodiments of the present invention address deficiencies of the art in respect to pacifiers and provide a novel and non-obvious pacifier with cheek stabilizers. In an embodiment of the invention, a pacifier includes a shield, an interior mouth stabilizer, and a nipple, where there is a space between the shield and the stabilizer to accommodate the baby's lips, and the stabilizer is configured to sit against the inner cheeks of the baby while the baby sucks on the nipple.

In one or more embodiments, a pacifier includes a shield and a body. The body includes a proximal end portion coupled to the shield, a distal end portion opposite the proximal end and defining a nipple, and one or more stabilizers defined between the proximal end and the distal end. The one or more stabilizers extend outwardly from the body and each define an axis perpendicular to a major longitudinal axis of the body.

In one aspect, the one or more stabilizers are sized and configured to be flush with an inner surface of a user's cheeks when the nipple is advanced within an oral cavity of the user.

In another aspect, the shield and the one or more stabilizers define a gap therebetween to accommodate the user's lips.

In another aspect, the one or more stabilizers are formed from at least one selected from the group consisting of rubber, plastic, silicon, or combinations thereof.

In another aspect, the one or more stabilizers includes a plurality of stabilizers.

In another aspect, the plurality of stabilizers includes a first stabilizer and a second stabilizer diametrically opposed to the first stabilizer.

In another aspect, the first and second stabilizers are coplanar.

In another aspect, the one or more stabilizers each have a first end and second end opposite the first end, the first and second ends each being coupled to the body and define an aperture therebetween.

In another aspect, the shield includes a first portion and a second portion each having a first end and a second end coupled to the proximal end portion of the body.

In another aspect, the shield lies in a plane perpendicular to the major longitudinal axis of the body.

In one or more embodiments, a pacifier includes a shield and a body. The body includes a proximal end portion coupled to the shield, a distal end portion opposite the proximal end portion and defining a nipple, and one or more stabilizers defined between the proximal end portion and the distal end portion.

In one aspect, the one or more stabilizers extend outwardly from the body and each define an axis perpendicular to a major longitudinal axis of the body.

In another aspect, the one or more stabilizers are sized and configured to be flush with an inner surface of a user's cheeks when the nipple is advanced within an oral cavity of the user.

In another aspect, the shield and the one or more stabilizers define a gap therebetween to accommodate the user's lips.

In another aspect, the one or more stabilizers are formed from at least one selected from the group consisting of rubber, plastic, silicon, or combinations thereof.

In another aspect, the one or more stabilizers includes a plurality of stabilizers.

In another aspect, the plurality of stabilizers includes a first stabilizer and a second stabilizer diametrically opposed to the first stabilizer.

In another aspect, the first and second stabilizers are coplanar.

In another aspect, the one or more stabilizers each have a first end and second end opposite the first end, the first and second ends each being coupled to the body and define an aperture therebetween.

In one or more embodiments, a pacifier for calming a baby includes a shield and a body. The body includes a nipple and one or more stabilizers that extend outwardly away from the body and each define an axis perpendicular to a major longitudinal axis of the body. The one or more stabilizers are disposed between the nipple and the shield.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a perspective view of an embodiment of an exemplary pacifier constructed in accordance with the principles of the present invention;

FIG. 2 is a front view of the pacifier of FIG. 1, in accordance with the principles of the present invention;

FIG. 3 is a rear view of the pacifier of FIGS. 1-2, in accordance with the principles of the present invention;

FIG. 4 is a perspective view of an embodiment of an exemplary pacifier constructed in accordance with the principles of the present invention;

FIG. 5 is a rear view of the pacifier of FIG. 4, in accordance with the principles of the present invention;

FIG. 6 is a perspective view of an embodiment of an exemplary pacifier constructed in accordance with the principles of the present invention; and

FIG. 7 is a top view of the pacifier of FIG. 6, in accordance with the principles of the present invention.

### DETAILED DESCRIPTION

The devices and methods disclosed herein are for providing a pacifier that includes a shield to prevent the baby from choking on the pacifier and a nipple at a distal end opposite the shield for the baby to suck on. The pacifier also includes an interior mouth stabilizer or stabilizers between the shield and the nipple and there is a space between the shield and the stabilizer to accommodate the baby's lips. The stabilizer(s) is configured to sit against the inner cheeks of the baby while the baby sucks on the nipple of the pacifier so that the pacifier does not easily fall out of the baby's mouth.

Before describing in detail exemplary embodiments that are in accordance with the disclosure, it is noted that components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Referring now to the drawing figures in which like reference designations refer to like elements, an embodiment of an exemplary pacifier is shown in FIG. 1, generally designated as “10.” The device components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the devices disclosed herein are not necessarily exclusive of each other and may be included in a variety of different combinations or configurations without departing from the scope and spirit of the invention.

Referring now to FIGS. 1-5, the pacifier 10 includes a body 12. The pacifier 10 may be injection molded as a single apparatus or the various components of the pacifier 10 may be assembled together separately. The body 12 has a proximal end portion 14 and a distal end portion 16 opposite the proximal end portion 14, and defines a longitudinal axis extending through the proximal and distal end portions 14, 16. In one or more embodiments, the proximal end portion 14 may have a circumference larger than a circumference of the distal end portion 16. However, in other embodiments, the proximal end portion 14 may have the same or smaller circumference than the distal end portion 16.

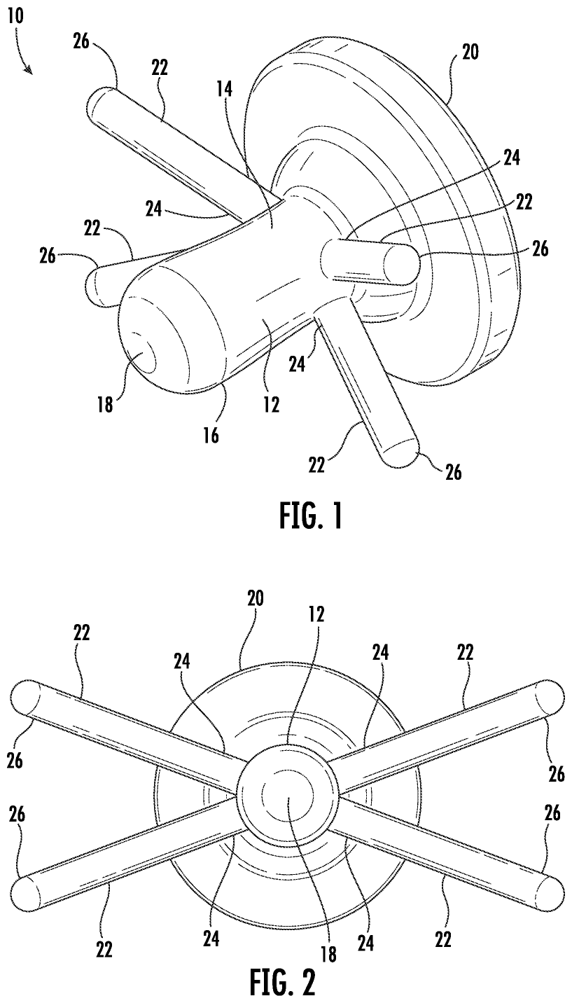

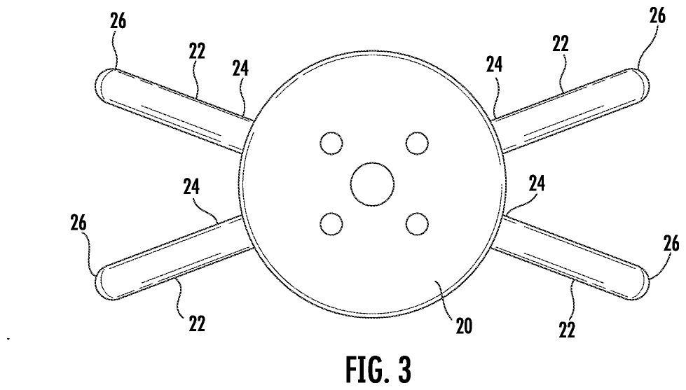

Continuing to refer to FIGS. 2-3, the distal end portion 16 defines an artificial nipple 20 that serves as a substitute for the nipple from the breast of a baby's mother. As a non-limiting example, the body 12, including the nipple 18, may be formed of rubber, plastic, silicone, combinations thereof, or any other material suitable and durable enough to withstand a baby's suckling throughout any given period of time. As used herein, “baby” may refer to a very young child, infant, and/or toddler belonging to, or is a member of, the Homo Sapiens species.

Further, the body 12 is coupled to a shield 20 at the proximal end portion 14. During use, the shield 20 remains on the outside of the baby's mouth and lips and acts as a barrier that prevents the pacifier 10 from fully entering the baby's mouth as the baby sucks on the nipple 18 or as the pacifier 10 is initially advanced into the baby's mouth—thus reducing the risk of choking. The shield 20 may be formed of rubber, plastic, silicone, combinations thereof, or any other similar material. In some embodiments, the shield 20 may be unitary with and formed from the same material as the body 12. In other embodiments, the shield 20 may be unitary with but formed from a different material than the body 12. Even further, in some embodiments, the shield 20 may not be unitary with the body 12, and instead, may be a separate piece that is releasably coupled to or interlocked with the body 12. As shown in FIGS. 2 and 3 the shield 20 may lie in a plane that is perpendicular, or substantially perpendicular, to the longitudinal axis of the body 12.

Continuing to refer to FIGS. 1-5, the body 12 may further include one or more interior mouth flanges or stabilizers 22 which are disposed between the proximal end portion 14 and the distal end portion 16. The stabilizers 22 are positioned such that a space or gap is defined between the stabilizers 22 and the shield 20 to accommodate a baby's lips around the body 12. In one or more embodiments each stabilizer 22 is configured to sit against, or be in contact with or flush with, the inner surface of the baby's cheeks while the baby sucks on the nipple 18 to prevent the pacifier 10 from easily falling out of the baby's mouth. For example, the pacifier 10 moves in a distal direction away from the baby's mouth when it falls out during use. As the pacifier 10 moves in the distal direction, the stabilizers 22 brace against the inner surface of the cheek to restrict or lessen the distal movement—thus reducing or eliminating the possibility of the pacifier 10 falling out of the baby's mouth.

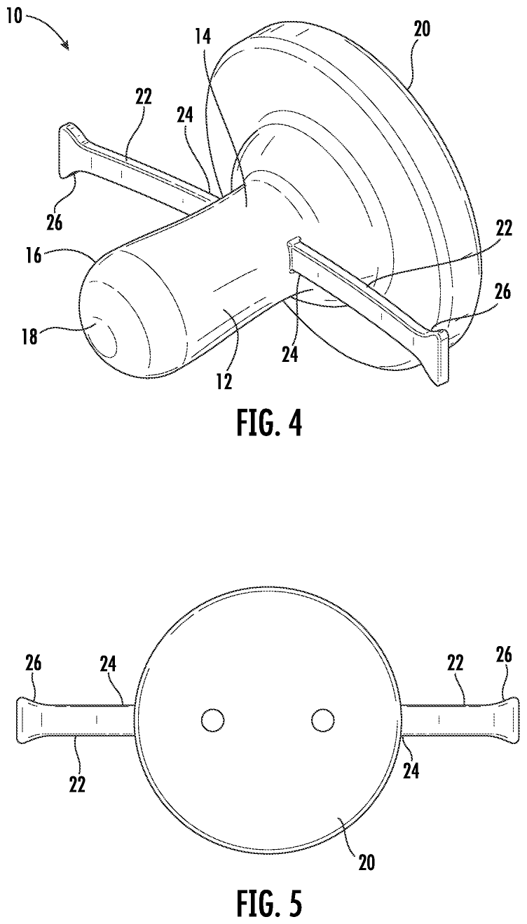

As shown in FIGS. 1-3, in one or more embodiments the pacifier 10 may include a first pair of stabilizers 22 and a second pair of stabilizers 22 opposite or diametrically opposed to the first pair. Alternatively, in some embodiments (such as shown in FIGS. 4-5), the body 12 may include only a single pair of stabilizers 22 such that each cheek of the baby is contacted by only one stabilizer 22. Each stabilizer 22 may have a first end 24 coupled to the body 12, an opposite second end 26 that extends outwardly away from the body 12, and defines an axis perpendicular to the major longitudinal axis of the body 12. In some embodiments, each stabilizer 22 may have a uniform diameter from the first end 24 to the second end 26. In other embodiments, the second end 26 may have a smaller or larger diameter than the first end 24 (for example, as shown in FIG. 5). As a non-limiting example, the first end 24 of each stabilizer may be rounded or blunted to prevent injury to the baby's mouth and increase comfort.

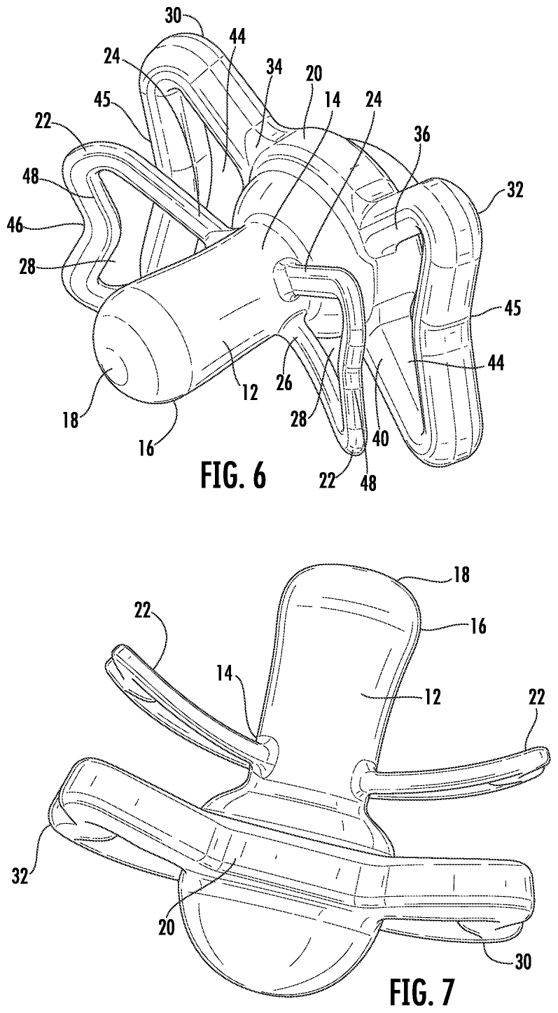

Now referring to FIGS. 6 and 7, another exemplary embodiment of the pacifier 10 is shown. As shown in FIG. 6, the first and second ends 24, 26 may each be coupled to the body 12 such that the first and second ends 24, 26 are adjacent to each other and define an aperture 28 therebetween. In one or more embodiments, the first and second ends 24, 26, may each be coupled to a portion of the body 12 proximate to or at the proximal end portion 14 such that each stabilizer 22 is in closer proximity to the shield 20 than the distal end portion 16 of the body 12. However, it is to be understood that the stabilizers 22 may be coupled to any portion of the body 22 between the proximal end portion 14 and distal end portion 16. In other words, in some embodiments, the stabilizers 22 may also be in closer proximity to the nipple 18 than the shield 20.

Further, as shown in FIG. 6, the shield 20 may include a first portion 30 and a second portion 32 each having a first end 34, 36 and an opposite second end 38, 40, respectively, coupled to the proximal end portion 14 of the body 12. When coupled to the body 12, the first ends 34, 36 and second ends 38, 40 may be separated by a portion of the outer surface of the body 12, and may also define an aperture 44 therebetween. The aperture 44 assists a user in being able to grasp the pacifier 10 by providing space for a user's fingers when wrapping them around the first portion 30 and/or second portion 32. In one or more embodiments, the first and second portions 30, 32 of the shield 20 may each lie in a plane coplanar and/or parallel to at least one stabilizer 22. Additionally, in one or more embodiments, the first and second portions 30, 32 of the shield 20 may each define a shape that is the same as, or matches, the shape defined the stabilizers 22. As such, in one or more embodiments, the first and second portions 30, 32 of the shield 20 may each also define a concave portion 45. However, it is to be understood that the first and second portions 30, 32 of the shield 20 may be larger or smaller in size, diameter, or surface area than the stabilizers 22.

Referring now to FIG. 7, each stabilizer 22 may include a concave portion 46 that is distal from the body 12 and concaves inwards towards the aperture 28. As each stabilizer 22 extends towards the concave portion 46, the lateral surface 48 of the stabilizer curves or arches towards the distal end portion 16 of the body 12 such that the concave portion 46 of the stabilizer 22 lies in a different plane than the first and second ends 24, 26. The curvature or arch of the stabilizers 22 may assist in the positioning and stability of the stabilizers 22 when in contact with the inner surface of the baby's cheek, and may also increase comfort for the baby by more closely resembling the curvature of the cheeks when positioned in the baby's mouth.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

What is claimed is:

1. A pacifier, comprising:
a shield;
a body including:
a proximal end portion coupled to the shield;
a distal end portion opposite the proximal end and defining a nipple; and
one or more stabilizers defined between the proximal end and the distal end; and
wherein the one or more stabilizers extend outwardly from the body and each define an axis perpendicular to a major longitudinal axis of the body.

2. The pacifier of claim 1, wherein the one or more stabilizers are sized and configured to be flush with an inner surface of a user's cheeks when the nipple is advanced within an oral cavity of the user.

3. The pacifier of claim 1, wherein the shield and the one or more stabilizers define a gap therebetween to accommodate the user's lips.

4. The pacifier of claim 1, wherein the one or more stabilizers are formed from at least one material selected from the group consisting of rubber, plastic, silicon, or combinations thereof.

5. The pacifier of claim 1, the one or more stabilizers includes a plurality of stabilizers.

6. The pacifier of claim 5, wherein the plurality of stabilizers includes a first stabilizer and a second stabilizer diametrically opposed to the first stabilizer.

7. The pacifier of claim 6, wherein the first and second stabilizers are coplanar.

8. The pacifier of claim 1, wherein the one or more stabilizers each have a first end and second end opposite the first end, the first and second ends each being coupled to the body and define an aperture therebetween.

9. The pacifier of claim 1, wherein the shield includes a first portion and a second portion each having a first end and a second end coupled to the proximal end portion of the body.

10. The pacifier of claim 1, wherein the shield lies in a plane perpendicular to the major longitudinal axis of the body.

11. A pacifier for calming a baby, comprising:
a shield; and
a body including:
a proximal end portion coupled to the shield;
a distal end portion opposite the proximal end portion and defining a nipple; and
one or more stabilizers defined between the proximal end portion and the distal end portion.

12. The pacifier of claim 11, wherein the one or more stabilizers extend outwardly from the body and each define an axis perpendicular to a major longitudinal axis of the body.

13. The pacifier of claim 11, wherein the one or more stabilizers are sized and configured to be flush with an inner surface of a user's cheeks when the nipple is advanced within an oral cavity of the user.

14. The pacifier of claim 11, wherein the shield and the one or more stabilizers define a gap therebetween to accommodate the user's lips.

15. The pacifier of claim 11, wherein the one or more stabilizers are formed from at least one material selected from the group consisting of rubber, plastic, silicon, or combinations thereof.

16. The pacifier of claim 11, wherein the one or more stabilizers includes a plurality of stabilizers.

17. The pacifier of claim 16, wherein the plurality of stabilizers includes a first stabilizer and a second stabilizer diametrically opposed to the first stabilizer.

18. The pacifier of claim 17, wherein the first and second stabilizers are coplanar.

19. The pacifier of claim 18, wherein the one or more stabilizers each have a first end and second end opposite the first end, the first and second ends each being coupled to the body and define an aperture therebetween.

20. A pacifier for calming a baby, comprising:
a body including:
a nipple; and
one or more stabilizers that extend outwardly away from the body and each define an axis perpendicular to a major longitudinal axis of the body.
